(19) United States
(12) Patent Application Publication
(10) Pub. No.: US 2026/0021752 A1
(43) Pub. Date: Jan. 22, 2026

(54) ASSEMBLY FOR ADJUSTING SEAT POSITION

(71) Applicant: LEAR CORPORATION, Southfield, MI (US)

(72) Inventors: Jian CHEN, Shanghai, Jiangsu (CN); Minghao YAN, Shanghai, Jiangsu (CN); Lianji JIN, Shanghai, Jiangsu (CN); Yue ZUO, Shanghai, Jiangsu (CN); Shuanghua YANG, Shanghai, Jiangsu (CN)

(73) Assignee: LEAR CORPORATION, Southfield, MI (US)

(21) Appl. No.: 18/875,358

(22) PCT Filed: May 10, 2023
(86) PCT No.: PCT/US2023/021717

§ 371 Date: Dec. 16, 2024

(30) Foreign Application Priority Data
Jun. 16, 2022 (CN) 202210689264.7

(51) Int. Cl. B60N 2/23; B60N 2/015; B60N 2/02

(52) U.S. Cl. CPC B60N 2/233; B60N 2/015; B60N 2/02253

(57) ABSTRACT

Seat assemblies and subassemblies such as for a vehicle are disclosed. The subassemblies may include joint assembly with a motor configured to move the seat assembly from a first position to a second position via the coordination between a rotating spindle and ring disposed around the spindle. The joint assembly may move an occupant to a predetermined position such as the zero-gravity position for greater comfort during extended use or lengthy travel.

### CROSS-REFERENCE TO RELATED APPLICATION

This application claims the benefit of International Application No. PCT/US2023/021717 filed on May 10, 2023, which claims the benefit of Chinese Patent Application No. 202210689264.7 filed Jun. 16, 2022, the disclosures of which are hereby incorporated by reference in their entirety.

### TECHNICAL FIELD

The present disclosure relates to subassemblies for positioning a vehicular seat.

### BRIEF DESCRIPTION OF THE DRAWINGS

FIG. 1 is a perspective view of a first embodiment of a seat assembly.

FIG. 2 is side view of a second embodiment of a seat assembly in a first position.

FIG. 3 is a side view of the second embodiment of the seat assembly in a second position.

FIG. 4 is a top perspective view of a drive assembly for controlling the position of the seat assembly.

FIG. 5 is a top perspective view of a joint assembly in a first position (e.g., retracted position).

FIG. 6 is a bottom perspective view of the joint assembly in a second position (e.g., extended position).

FIG. 7 is a bottom perspective view of another embodiment of a seat assembly.

### DETAILED DESCRIPTION

Embodiments of the present disclosure are described herein. It is to be understood, however, that the disclosed embodiments are merely examples and other embodiments can take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

This disclosure is not limited to the specific embodiments and methods described below, as specific components and/or conditions may vary. Furthermore, the terminology used herein is used only for the purpose of describing particular embodiments and is not intended to be limiting in any way.

When various components are described by providing their structural arrangement with other components such as being attached, connected, fixed, in communication with, etc., it should be understood that those same components are disclosed as being configured to provide that same structural arrangement such as configured to be attached, connected, fixed, or in communication with.

The term “substantially” or “generally” may be used herein to describe disclosed or claimed embodiments. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

The term “generally perpendicular” means within a range of perpendicular that accommodates manufacturing tolerances.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

A subassembly for varying the position of a seat such as a vehicle seat is disclosed. The subassembly includes an actuator and a first guide configured to cooperate with a second guide cooperating with a joint. In a refinement, the actuator is a motor. The actuator is configured to be assembled in a seat assembly and defines a rotary axis. The first guide defines a translation axis and cooperates with the actuator to drive the first or second guide such that the first or second guide translate relative to the translation axis. The first guide also cooperates with the second guide such that a joint in cooperation with the first or second guide moves from a retracted position to an extended position. In one or more embodiments, the first guide includes a spindle or an annular linkage, and the second guide includes the other of the spindle or the annular linkage. The spindle and annular linkage cooperate such that during actuation of the actuator the annular linkage translates relative to the spindle. In a refinement, the first guide includes a first screw-like groove that corresponds to a second screw-like groove such that when the first guide rotates, via the actuator, the second guide translates along the first guide. In a refinement, the joint includes a first arm pivotally attached to the second arm at a pivot point. The first arm is connected to a seat frame, the second arm is connected to a base of a seat assembly, and the first or second guide is connected to the first or second arm such that when the joint extends or retracts the seat frame pivots. In an embodiment, the first guide defines a translation axis that may be different from the rotary axis such as being generally perpendicular to the rotary axis.

A seat assembly including a base, a seat frame cooperating with the base, a drive assembly having an actuator defining a rotary axis, a first guide defining a translation axis and cooperating with the actuator such that the actuator drives the first guide, and a second guide cooperating with the first guide to actuate a joint. The seat frame defines a seat bottom and/or a seat back. The first or second guide cooperates with the joint on the base or the seat frame such that when the actuator drives the first or second guide, the translation of the first or second guide moves the seat frame to the first position or the second position. In a refinement, the actuator is a motor. In one or more embodiments, the first guide and second guides include a spindle and an annular linkage such as a ring that is configured to be disposed around the spindle during operation. In a refinement, the joint includes a first arm pivotally connected to a second arm at a first pivot point. In a refinement, the second guide is fixed to the base. In an embodiment, the first arm is pivotally connected to the seat frame and the second arm is pivotally connected to the base. In a refinement, the drive assembly includes a third guide defining a second translation axis and is configured to cooperate with a fourth guide that cooperates with a second joint on the base or seat frame, such that when the actuator drives the third or fourth guide, the third or fourth guide translates relative to the second translation axis to move the seat to the first position or the second position. In a refinement, the base is secured to a vehicle floorboard. In one or more embodiments, the actuator has a shaft extending along the rotary axis that is in mechanical communication with the first guide such that when the shaft rotates the first guide rotates.

A seat assembly including a seat frame and a joint assembly for changing the position of the seat frame is disclosed. The seat frame is configured to be attached to a stationary base rail. The joint assembly has an actuator having a rotary axis, a transmission, a first guide, a second guide, and a joint. The actuator cooperates with the transmission to rotate the first guide. The first guide is in communication with the second guide. The joint cooperates with the first or second guide and is connected to the seat frame or the stationary base rail such that the first or second guide steers the other of the first or second guide from a first position to a second position. The first and second positions corresponding to a retracted position and an extended position of the joint. The retracted position and extended position corresponding to different seat frame positions. In a refinement, the first or second guide include a spindle and the other of the first and second guides include an annular linkage such that the spindle or annular linkage translates along the other of the spindle or annular linkage during actuation of the actuator. In one or more embodiments, the different seat frame positions may include a predetermined zero-gravity position. In a refinement, the transmission may include a gearbox.

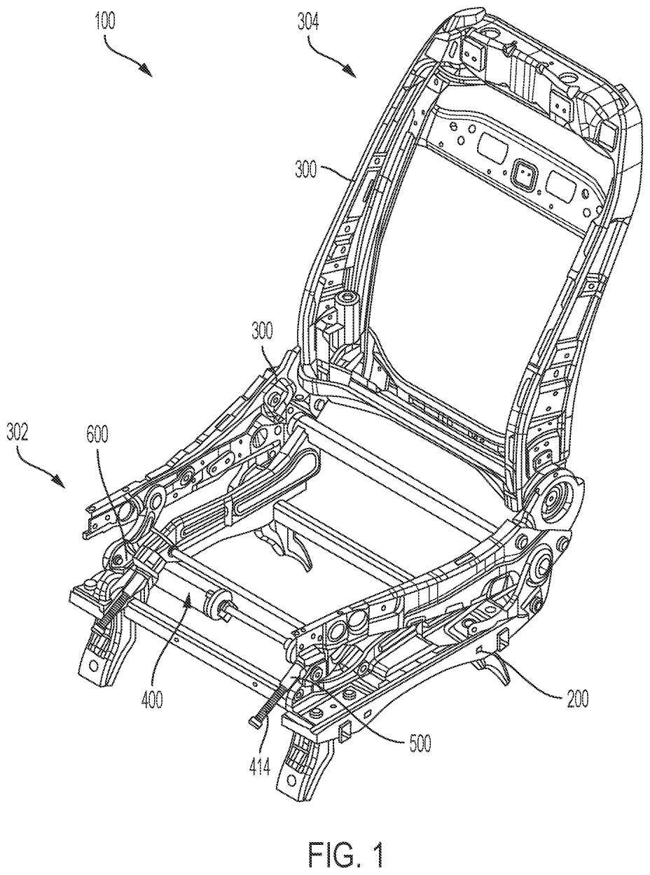

Referring to FIG. 1, a seat assembly 100 is disclosed. In a refinement, the seat assembly 100 is suitable for a vehicle. The seat assembly 100 includes one or more subassemblies configured to change the position of the seat assembly 100. The seat assembly 100 includes a frame assembly having a base 200 and a seat frame 300, a drive assembly 400, a first guide 414, a second guide 500, and/or a joint assembly 600.

The base 200 acts as a foundation to support the seat frame 300. In a refinement, the base 200 is fixed to a vehicle such as to a vehicle body and/or floorboard. In a variation, the base 200 may be connected (e.g., attached/fixed/fastened/secured) to or resting on a surface (e.g., the floor) such that is does not move relative to the floor during use. For example, the base 200 is bolted to a vehicle floorboard such that it does not move relative to the vehicle.

The base 200 cooperates with the seat frame 300 such that the base 200 remains stationary while the seat frame moves, i.e., the seat frame moves relative to the base. In a refinement, the base 200 is connected to the seat frame 300 or configured to be connected to the seat frame 300 such as by a joint assembly 600 and/or a first pivot point 202. In a refinement, the base 200 and seat frame 300 are connected by one or more fasteners such as by nuts and bolts, interference fits, and/or other suitable attachment mechanisms. In another refinement, the base 200 may include one or more stationary rails and/or legs mounted to the surface such as the floor.

The base and seat frame 300 are made of a shape and material sufficient to support the subassemblies and an occupant. For example, the base 200 and seat frame 300 are made of a rigid material suitable for supporting the subassemblies and/or the occupant. For example, the base 200 and/or seat frame 300 may be made of metal (e.g., steel or aluminum), plastic, wood, or a combination thereof. For example, the seat frame 300 defines a seat bottom 302 and/or a seat back 304. The seat bottom 302 and/or seat back 304 moves to a position selected by an occupant or to a predetermined position such as a position that alleviates stresses on an occupant (e.g., the zero-gravity position). In a refinement, the zero-gravity position is a position where the seat is balanced on the first pivot point 202. This may be achieved by moving (e.g., pivoting) the seat assembly 100 about or around the first pivot point 202.

For example, a front portion of the seat bottom 302 is raised to pivot the seat assembly 100 at the first pivot point 202. As the front portion of the seat bottom 302 is raised, the upper portion of the seat back 304 is lowered. The new adjusted position may alleviate pressure and/or contraction on the lower spine of an occupant such that it is more comfortable for extended use or travel. In a refinement, the seat bottom 302 and the seat back 304 may move relative to one another and/or relative to the first pivot point 202.

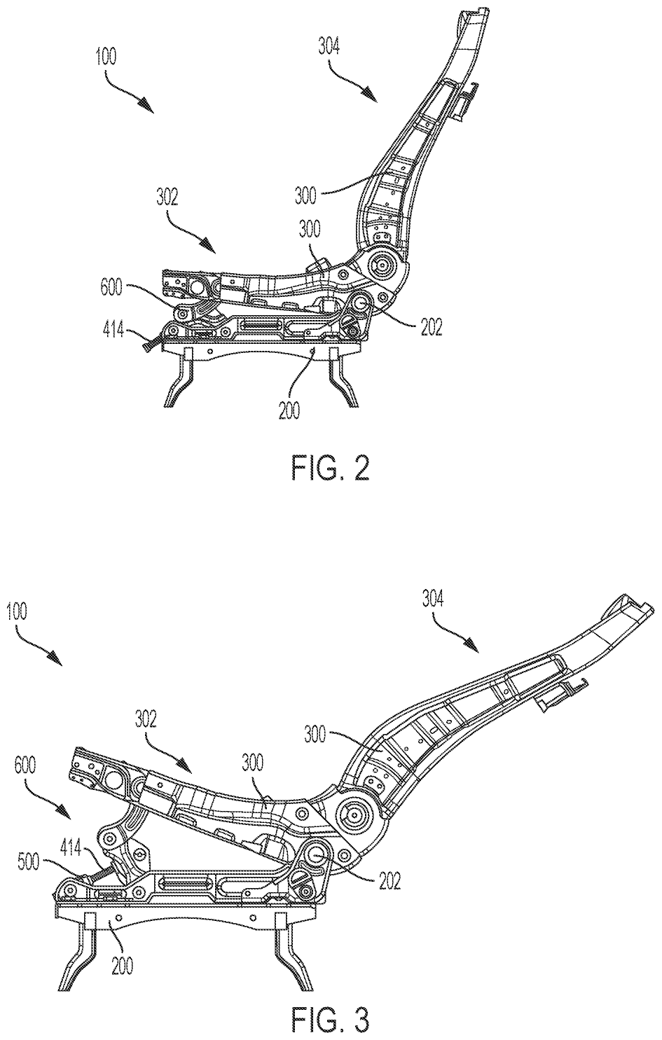

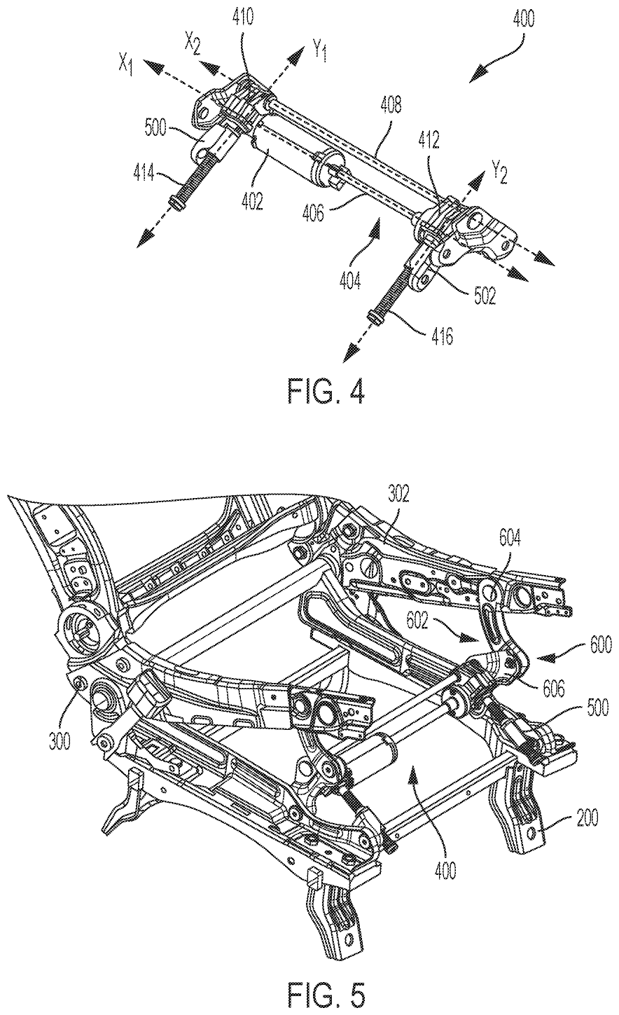

Referring to FIG. 4, the drive assembly 400 is configured to move the seat frame 300 such as by driving the joint assembly 600 that moves the seat frame 300 from a first position (shown in FIG. 2) to a second position (shown in FIG. 3) and/or vice versa (i.e., from the second position to the first position). The drive assembly 400 includes an actuator 402 defining a rotary axis X₁. The actuator 402 cooperates with a first guide 414 such that during actuation of the actuator 402 the first guide 414 is rotated relative to a translation axis Y₁ defined by the first guide 414. Alternatively, the first guide 414 is pivoted relative to the rotary axis X₁. The first guide 414 cooperates with a second guide 500 to actuate the joint 600 such as by causing translation of the first or second guides via the rotational or pivotal action.

For example, the actuator 402 includes a shaft 406 extending along the rotary axis X₁ (i.e., the shaft defines axis X₁). In a refinement, the shaft 406 extends from the actuator 402 in a first direction and/or a second direction opposite the first direction. The actuator 402 drives the shaft 406 such that the shaft 406 rotates (or alternatively pivots) axially about the rotary axis X₁. In a refinement, the actuator 402 may include a motor.

In some embodiments, one or more (e.g., a plurality) of guides such as the first guide 414 and a third guide 416 cooperate with the actuator 402 such that, during operation of the actuator 402, one or more guides rotates relative to a translation axis Y₁. Alternatively, the one or more guides may pivot relative to the rotary axis X₁. For example, the first guide 414 cooperates with a second guide 500 and the third guide 416 cooperates with a fourth guide 502. Each guide is of a shape and size such that corresponding guides work together to actuate the joint assembly 600. In a refinement, each pair of guides collectively includes a female portion and male portion. For example, the first and third guides 414, 416 may be spindles extending in a third direction that is different than the first and second directions of the shaft. Each guide defines a translation axis Y₁/Y₂. In a refinement, the translation axes Y₁, Y₂ may be different from the rotary axis X₁ (i.e., not coaxial). In another refinement, the translation axes Y₁, Y₂ are not parallel with the rotary axis X₁. For example, the translation axes Y₁, Y₂ may be perpendicular or generally perpendicular to the rotary axis X₁.

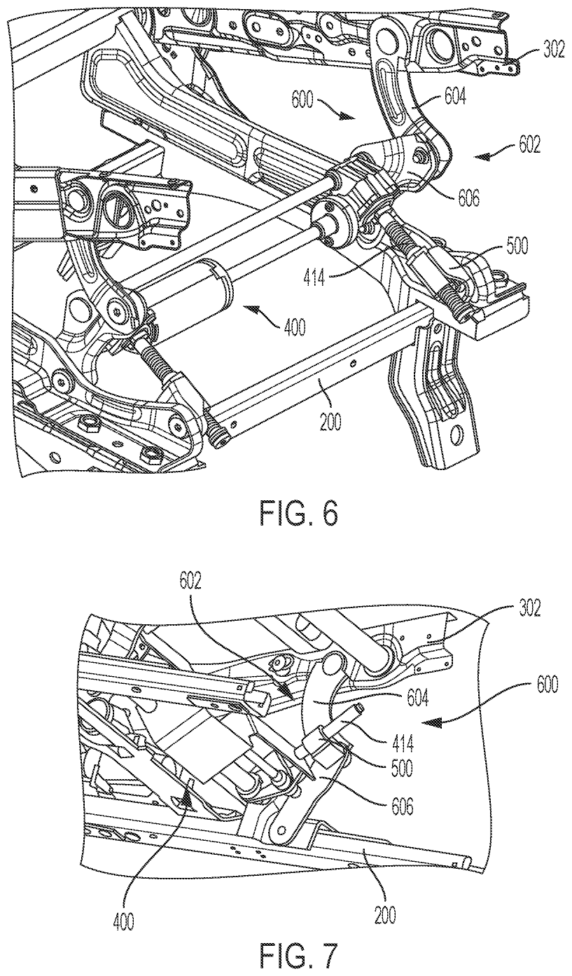

In a refinement, as shown in FIGS. 5-6, the second and fourth guides 500, 502 are annular linkages such as rings, hoops, hooks, bands, halos, loops, or any suitable shape configured to be disposed respectively around the spindles such that when the first and third guides 414, 416 (e.g., spindles) are rotated about the respective translations axis Y₁, Y₂, via the actuator, the second and fourth guides 500, 502 (e.g., rings) translate along the first and third guides 414, 416 (e.g., spindles). For example, second guide 500 translates along the translation axis Y₁ and/or first guide 414 from a first location to a second location (e.g., from a first end to a second end). It should be understood that the opposite configuration may also be possible, i.e., the first and third guides 414, 416 may be annular linkages and the second and fourth guides 500, 502 may be spindles. Alternatively, as shown in FIG. 7, the first and third guides 414, 416 (e.g., transversely) extend from the shaft 406 such that when the shaft pivots the first and third guides 414, 416 may pivot around the shaft/rotary axis causing translation.

As the first and third guides 414, 416 move they guide, steer, and/or escort the second and fourth guides 500, 502. At least one of the guides cooperates with the joint assembly 600 while the corresponding guide is fixed. For example, the first and third guides 414, 416 are connected to or disposed respectively on joints (e.g., a first joint and a second joint) of the joint assembly 600 and the second and fourth guides 500, 502 cooperate with the base 200 such that rotation of the first and third guide actuates the joints. Alternatively, the second and fourth guides 500, 502 may be connected to or disposed on the joints of the joint assembly 600 and the first and third guides 414, 416 may be connected to or disposed on the shaft such that pivoting of the first and third guides 414, 416 may actuate the joints.

The joint assembly 600 includes a joint 602. The joint 602 is configured to at least move from an initial position (e.g., retracted position shown in FIG. 5), to a latter position (e.g., extended position shown in FIG. 6). The retracted and extended positions of the joint 602 correspond to the first and second position of the seat assembly 100. In a refinement, the joint assembly 600 is disposed proximate or under the front portion of a seat bottom 302 such that when it extends it raises the front portion of the seat bottom 302 and when it retracts it lowers the front portion of the seat bottom 302.

In a variation, the actuator 402 may be configured to rotate a second shaft 408 defining a second rotary axis X₂ that is different from the first rotary axis X₁ and extending in the first and/or second directions. The second shaft 408 may be configured to rotate or pivot such that the first guide rotations or the first shaft 406 pivots in response to the second shaft 408 rotating or pivoting (or vice versa). In one or more embodiments, the first and second rotary axes X₁, X₂ may be parallel. In a refinement, at least one of the shafts 404 is connected to one or more transmissions (e.g., gearboxes) such as a first and a second transmission 410, 412. The one or more transmissions may facilitate movement, rotation, and/or pivoting of one or more of the shafts 404 and/or guides. The gearboxes include one or more gears arranged inside a casing. In a refinement, each transmission is disposed between a shaft and a guide.

In one or more embodiments, the one or more gears rotate the first and third guides (e.g., spindles) which may each have a screw-like groove (e.g., helical ramp) that corresponds to a screw-like groove on the corresponding guides (e.g., second and fourth guides) such that the corresponding guides traverses along the translation axes respectively, i.e., each guide may be threaded and have a corresponding threaded guide. For example, the guides may include a ball screw, a lead screw, or any other mechanism configured to convert rotary motion to linear motion. Alternatively, the teeth of the one or more gears may interdigitate with teeth of the first or second shaft such that when the one rotates or pivots the other likewise rotates or pivots. In yet another alternative, the gears may be arranged to climb or move along a guide (e.g., a spindle). For example, each spindle may include a series of steps that interdigitate with the one or more gears such that the gears move along the teeth like a ladder.

The actuator 402 is fixed or stationary such that, during operation, the shaft(s) rotate or pivot and the actuator 402 does not. In a refinement, the actuator 402 is connected/fixed to the base 200. For example, the shaft 406 extends from the actuator 402 from both a first portion in the first direction and a second portion in the second direction. Each shaft includes a first end and a second end. In a refinement, the first and third guides 414, 416 (e.g., spindles) and/or first and second transmissions 410, 412 are respectively located at or proximate to the first and second ends. The actuator 402 preferably operates in both axial directions such that the guides can be moved bi-directionally to move the seat assembly 100 from a first position (e.g., FIG. 2) to a second position (e.g., FIG. 3) and back to the first position (e.g., FIG. 2).

In short, the actuator 402 drives the one or more guides by rotating the shaft 408 which is in communication with one or more transmissions including gearboxes, gears, belts, and/or additional shafts that, for example, rotate the guides respectively around translational axes Y₁, Y₂. Alternatively, the actuator 402 may drive the one or more guides by pivoting the shaft 408 such that the guides pivot around the shaft/rotary axis X₁. In yet another embodiment, the actuator 402 may engage a transmission that translates the guides along the translational axis, for example, engaging a gear to climb along notches on the guide like a ladder.

The joint assembly 600 includes one or more joints such as joint 602 having a first arm 604 pivotally connect to a second arm 606. In a variation, the first arm 604 is connected to the seat frame 300 such as at the front portion of the seat bottom 302 and the second arm 606 is connected to the base 200. In a refinement, the joint 602 is pivotally connected to the base 200 and/or seat frame 300 via the first arm 604 and/or second arm 606. For example, the first arm 604 is pivotally connected to the seat frame 300 at a second pivot point, the first and second arms 604, 606 are pivotally connected to each other at a third pivot point, and the second arm 606 is pivotally connected to the base 200 at a fourth pivot point. In a refinement, the pivot points are disposed at opposite ends of each arm. The plurality of pivot points at opposite ends provides a greater range of motion. One or more guides cooperate with or are disposed on the first or second arm 604/606. For example, a guide is disposed at and/or proximate to the third pivot point such that it is easier or takes less force to actuate the joint.

The seat assembly 100 may include various other subassemblies and/or components such as but not limited to cushions, ventilation assemblies, massage assemblies, electronic assemblies, a carrier board, and/or a trim cover.

Although described herein with first and second components it should be understood that three, four, five, or more of the assemblies described herein may be included. For example, an assembly with two shafts, three spindles/gearboxes, and five joints may be used.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A subassembly for varying a position of a seat comprising:
an actuator assembled in a seat assembly and defining a rotary axis;
a first guide in cooperation with the actuator and defining a translation axis;
a second guide cooperating with the first guide; and
a joint in cooperation with the first or second guide such that during actuation of the actuator the joint moves from a retracted position to an extended position and the first or second guide translates relative the translation axis.

2. The subassembly of claim 1, wherein the first guide comprises a spindle or an annular linkage and the second guide comprises the other of the spindle or the annular linkage such that during actuation of the actuator the annular linkage translates relative to the spindle.

3. The subassembly of claim 2, wherein the first guide has a first screw-like groove that corresponds a second screw-like groove such that when the first guide is rotated via the actuator the second guide translates along the first guide.

4. The subassembly of claim 1, wherein the actuator is a motor.

5. The subassembly of claim 1, wherein the joint includes a first arm and a second arm pivotally attached, the first arm being connected to a seat frame, the second arm being connected to a base, and the first guide being connected to the first or second arm such that when the joint extends or retracts the seat frame pivots.

6. The subassembly of claim 1, further comprising a transmission cooperating with the actuator to rotate the first guide.

7. A seat assembly comprising:
a base;
a seat frame disposed on the base and defining a seat bottom and/or seat back;
a drive assembly having an actuator, the drive assembly moving the seat frame relative to the base from a first position to a second position;
a first guide and a second guide operably connected to the first guide; and
a joint on the base or the seat frame;
wherein when the actuator drives the first or second guide, the translation of the first or second guide moves the seat frame to the first position or the second position.

8. The seat assembly of claim 7, wherein the actuator is a motor.

9. The seat assembly of claim 7, wherein the first guide and second guide comprise a spindle and an annular ring configured to be disposed around the spindle.

10. The seat assembly of claim 7, wherein the joint includes a first arm pivotally connected to a second arm at a first pivot point.

11. The seat assembly of claim 10, wherein the second guide is fixed to the base.

12. The seat assembly of claim 11, wherein the first arm is pivotally connected to the seat frame and the second arm is pivotally connected to the base.

13. The seat assembly of claim 7, wherein the actuator defines rotary axis, and the first guide defines a first translation axis that is different than the rotary axis.

14. The seat assembly of claim 7, wherein the drive assembly includes a third guide defining a second translation axis and configured to cooperate with a fourth guide, the third or fourth guide cooperating with a second joint on the base or seat frame such that when the actuator drives the third or fourth guide, the third or fourth guide translates relative to the second translation axis to move the seat to the first position or the second position.

15. The seat assembly of claim 7, wherein the base is configured to be secured to or is secured to a vehicle floorboard.

16. The seat assembly of claim 13, wherein the rotary axis is generally perpendicular to the first translation axis.

17. The seat assembly of claim 13, wherein the actuator further comprises a shaft extending along the rotary axis and being in mechanical communication with the first guide such that when the shaft rotates the first guide rotates.

18. A seat assembly comprising:
a seat frame configured to be attached to a stationary base rail; and
a joint assembly comprising:
an actuator defining a rotary axis;
a transmission cooperating with the actuator to rotate a first guide, the first guide being in communication with a second guide; and
a joint cooperating with the first or second guide and being configured to be connected to the seat frame or the stationary base rail such that the first or second guide steers the other of the first or second guide from a first position to a second position, the first and second positions corresponding to a retracted position and an extended position of the joint, wherein the retracted position and extended position correspond to different seat frame positions.

19. The seat assembly of claim 18, wherein the first or second guide comprises a spindle and the other of the first and second guide comprises an annular linkage such that the spindle or annular linkage may translate along the other of the spindle or the annular linkage during actuation of the actuator.

20. The seat assembly of claim 18, wherein the different seat frame positions include a predetermined position.
